(19) United States
(12) Patent Application Publication
(10) Pub. No.: US 2020/0099477 A1
(43) Pub. Date: Mar. 26, 2020

(54) Hybrid Automatic Repeat Request Feedback Procedures For Uplink Transmission In Mobile Communications

(71) Applicant: MediaTek Singapore Pte. Ltd., Singapore (SG)

(72) Inventor: Mohammed S Aleabe Al-Imari, Cambridge (GB)

(21) Appl. No.: 16/580,236

(22) Filed: Sep. 24, 2019

Related U.S. Application Data
(60) Provisional application No. 62/735,912, filed on Sep. 25, 2018.

(51) Int. Cl. H04L 1/18; H04L 1/00; H04W 72/12

(52) U.S. Cl. CPC H04L 1/1812; H04W 72/1268; H04L 1/0073

(57) ABSTRACT

Various solutions for hybrid automatic repeat request (HARQ) feedback procedures for uplink transmission with respect to user equipment and network apparatus in mobile communications are described. An apparatus may receive downlink control information (DCI) from a network node. The apparatus may determine whether the DCI is used to indicate HARQ feedback information corresponding to an uplink transmission. The apparatus may determine the HARQ feedback information according to the DCI in an event that the DCI is used to indicate the HARQ feedback information corresponding to the uplink transmission. The apparatus may determine whether to terminate the uplink transmission according to the HARQ feedback information.

### CROSS REFERENCE TO RELATED PATENT APPLICATION(S)

The present disclosure is part of a non-provisional application claiming the priority benefit of U.S. Patent Application No. 62/735,912, filed on 25 Sep. 2018, the content of which is incorporated by reference in its entirety.

### TECHNICAL FIELD

The present disclosure is generally related to mobile communications and, more particularly, to hybrid automatic repeat request (HARQ) feedback procedures for uplink transmission with respect to user equipment and network apparatus in mobile communications.

### BACKGROUND

Unless otherwise indicated herein, approaches described in this section are not prior art to the claims listed below and are not admitted as prior art by inclusion in this section.

In New Radio (NR), the network node may configure two types of uplink grants for the user equipment (UE) to perform uplink transmissions. The uplink grant may indicate some specific radio resources (e.g., time and frequency resources) for the UE to perform uplink transmission. One type of the uplink grant may comprise the dynamic grant. The dynamic grant may be configured based on the UE's request. For example, the UE may transmit a prior request (e.g., service request (SR), random-access channel (RACH) request or buffer status report (BSR)) to the network. After receiving the request, the network may configure the dynamic grant according to UE's request for the UE to perform uplink data transmission.

The other type of the uplink grant may comprise the configured grant. The configured grant may be configured by the network without UE's request. The uplink transmission based on the configured grant may also be called as a grant-free transmission or a semi persistent scheduling (SPS) transmission. The uplink grant-free transmission or the SPS transmission may be used to address the requirements of several services in wireless communications. For example, it can be used for voice over internet protocol (Vol P) services or ultra-reliable and low latency communications (URLLC) services in Long-Term Evolution (LTE) or NR. The UE may be configured to transmit its uplink data on the configured grant without transmitting a prior request to improve the transmission latency. The network may pre-configure specific radio resources (e.g., time and frequency resources) for the UE to perform the uplink SPS/grant-free/configured grant transmissions.

Given that the resources for configured grant are pre-allocated to the UE, it is expected that the network node will allocate the same resources for multiple UEs. This may enhance the spectral efficiency, especially when the traffic is sporadic. When the UE is configured with repetitions for uplink transmission, the network node may successfully decode the uplink data from the first few repetitions. In this case, the reaming repetitions are not needed, and it could cause interference to another UE.

However, the current specifications and procedures in NR do not support explicit HARQ feedback for uplink transmission. Currently, in an event that the network node successfully decodes the uplink packet, it has to send another uplink grant with toggled new data indicator (NDI) value for the same HARQ process identifier (ID). In some cases, there is a need to send HARQ feedback without scheduling new packets. For example, for the cases there is no further data to be transmitted by the UE.

Accordingly, how to send/receive HARQ feedback for an uplink transmission, and when the UE should monitor the DCI for HARQ feedback are important issues in the newly developed wireless communication network. As monitoring the HARQ-feedback may introduce more complexity to the UE, it is essential to consider the complexity of monitoring the HARQ feedback in the design. Therefore, it is needed to provide proper HARQ feedback procedures for uplink transmission.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to HARQ feedback procedures for uplink transmission with respect to user equipment and network apparatus in mobile communications.

In one aspect, a method may involve an apparatus receiving DCI from a network node. The method may also involve the apparatus determining whether the DCI is used to indicate HARQ feedback information corresponding to an uplink transmission. The method may further involve the apparatus determining the HARQ feedback information according to the DCI in an event that the DCI is used to indicate the HARQ feedback information corresponding to the uplink transmission. The method may further involve the apparatus determining whether to terminate the uplink transmission according to the HARQ feedback information.

In one aspect, a method may involve an apparatus performing an uplink transmission. The method may also involve the apparatus determining whether at least one of an uplink transmission type and an uplink transmission parameter corresponding to the uplink transmission meets a condition. The method may further involve the apparatus determining whether to monitor DCI used to indicate HARQ feedback information corresponding to the uplink transmission. The method may further involve the apparatus monitoring the DCI in an event that at least one of the uplink transmission type and the uplink transmission parameter meets the condition.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a block diagram of an example communication apparatus and an example network apparatus in accordance with an implementation of the present disclosure.

FIG. 4 is a flowchart of an example process in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to HARQ feedback procedures for uplink transmission with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

In NR, the network node may configure two types of uplink grants for the UE to perform uplink transmissions. The uplink grant may indicate some specific radio resources (e.g., time and frequency resources) for the UE to perform uplink transmission. One type of the uplink grant may comprise the dynamic grant. The dynamic grant may be configured based on the UE's request. For example, the UE may transmit a prior request (e.g., SR, RACH request or BSR) to the network. After receiving the request, the network may configure the dynamic grant according to UE's request for the UE to perform uplink data transmission.

The other type of the uplink grant may comprise the configured grant. The configured grant may be configured by the network without UE's request. The uplink transmission based on the configured grant may also be called as a grant-free transmission or an SPS transmission. The uplink grant-free transmission or the SPS transmission may be used to address the requirements of several services in wireless communications. For example, it can be used for Vol P services or URLLC services in LTE or NR. The UE may be configured to transmit its uplink data on the configured grant without transmitting a prior request to improve the transmission latency. The network may pre-configure specific radio resources (e.g., time and frequency resources) for the UE to perform the uplink SPS/grant-free/configured grant transmissions.

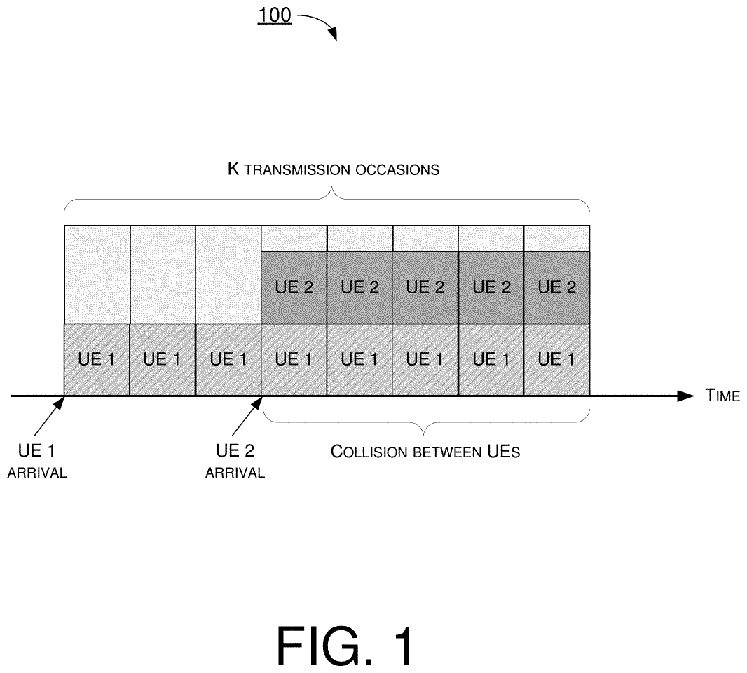

Given that the resources for configured grant are pre-allocated to the UE, it is expected that the network node will allocate the same resources for multiple UEs. This may enhance the spectral efficiency, especially when the traffic is sporadic. When the UE is configured with repetitions (e.g., K>1) for uplink transmission, the network node may successfully decode the uplink data from the first few repetitions. In this case, the reaming repetitions are not needed, and it could cause interference to another UE. FIG. 1 illustrates an example scenario 100 under schemes in accordance with implementations of the present disclosure. Scenario 100 involves a plurality of UEs and a network node, which may be a part of a wireless communication network (e.g., an LTE network, an LTE-Advanced network, an LTE-Advanced Pro network, a 5G network, an NR network, an IoT network or an NB-IoT network). UE 1 and UE 2 may be configured with a plurality of uplink transmission occasions (e.g., K transmission occasions). K may be an integer greater than 1. UE 1 starts transmitting its data on the first transmission occasion. UE 2 starts transmitting the data on the fourth transmission occasion. The network node may have high probability to successfully decode the UE 1 data from the first few repetitions. For example, about 95.78% of the packets will be successfully decoded from the first repetition when UE 1 is configured with K=8. An early termination of the UE's configured-grant transmission could reduce any further collision between the UEs in the remaining repetitions, which enhances the chance of successfully decoding the UE's data. Hence, it is essential to study the achievable gains of supporting explicit HARQ for configured-grant transmission.

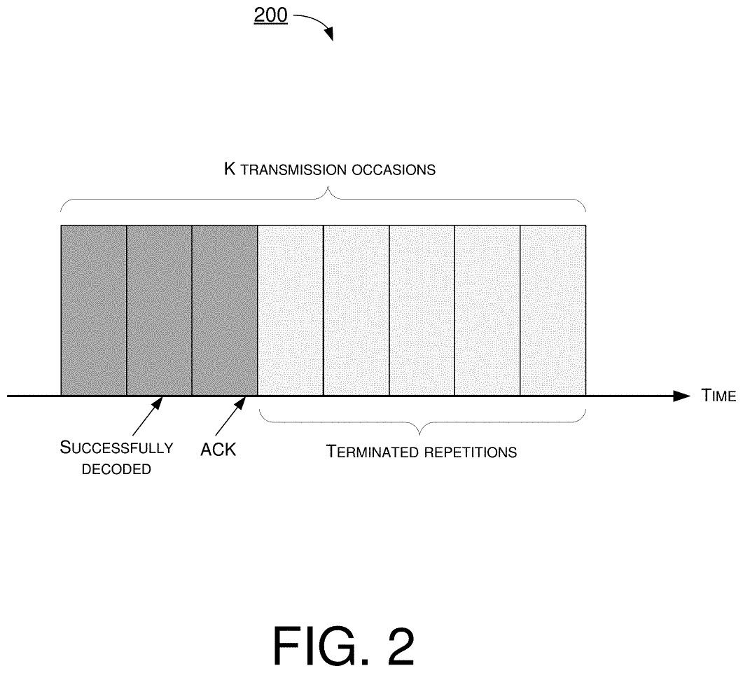

FIG. 2 illustrates an example scenario 200 under schemes in accordance with implementations of the present disclosure. Scenario 200 involves a UE and a network node, which may be a part of a wireless communication network (e.g., an LTE network, an LTE-Advanced network, an LTE-Advanced Pro network, a 5G network, an NR network, an IoT network or an NB-IoT network). Scenario 200 illustrates the advantage of using explicit HARQ feedback to enable early termination. It is assumed that the network node is able to send an ACK if the UE's data has been successfully decoded. Once the UE receives the ACK feedback, it terminates the remaining repetitions of the configured-grant transmission. A significant reduction in the percentage of collision between UEs can be achieved when using ACK feedback for early termination. The interference between UEs may be significantly reduced. The UE may also be able to save its power for transmission the remaining repetitions of the configured-grant transmission. On the other hand, in addition to the performance gain that can be achieved with acknowledgement (ACK) feedback for early termination, reducing the number of colliding UEs at the network node can decrease the required complexity to detect/decode the UEs' data at the network node.

However, the current specifications and procedures in NR do not support explicit HARQ feedback for uplink transmission. Currently, in an event that the network node successfully decodes the uplink packet, it has to send another uplink grant with toggled NDI value for the same HARQ process ID. In some cases, there is a need to send HARQ feedback without scheduling new packets. For example, for the cases there is no further data to be transmitted by the UE. Alternatively, when the UE is configured with repetitions, HARQ feedback can be used to terminate the remaining repetitions in an event that the network node successfully decoded the packet from the initial set of repetitions. Accordingly, how to send/receive HARQ feedback for an uplink transmission of configured grant, and when the UE should monitor the DCI for HARQ feedback are important issues in the newly developed wireless communication network. As monitoring the HARQ-feedback may introduce more complexity to the UE, it is needed to consider the complexity of monitoring the HARQ feedback in the design.

In view of the above, the present disclosure proposes a number of schemes pertaining to HARQ feedback procedures for uplink transmission via configured grant with respect to the UE and the network apparatus. According to the schemes of the present disclosure, methods and apparatus for sending/receiving explicit HARQ feedback, and procedures to reduce the UE complexity in monitoring for explicit HARQ feedback are provided. Downlink feedback information (DFI) including HARQ feedback for configured-grant transmission is introduced. The design of a DCI to transmit HARQ feedback of transmission of configured grant, and the procedures for monitoring a DCI that carry HARQ feedback for an uplink transmission will be provided in the present disclosure. The UE may adaptively initiate retransmission for a HARQ process that was initially transmitted via configured-grant mechanism when it receives negative acknowledgement (NACK) feedback via DFI for the corresponding HARQ process. Explicit HARQ feedback can reduce the collision between the UEs in uplink configured-grant transmission, which can enhance the system performance and reduce the complexity of decoding the uplink data at the network node.

Specifically, the UE may be configured to receive a DCI from the network node. The UE may be configured to determine whether the DCI is used to indicate HARQ feedback information corresponding to an uplink transmission (e.g., with HARQ feedback information indicated in the DCI). The UE may be configured to determine the HARQ information according to the DCI in an event that the DCI is used to indicate the HARQ feedback information corresponding to the uplink transmission. The UE may be configured to determine whether to terminate the uplink transmission according to the HARQ information. In an event that the UE determines that the HARQ feedback information is an ACK, the UE may terminate the uplink transmission (e.g., the remaining repetitions). In an event that the UE determines that the HARQ feedback information is a NACK, the UE may continue to perform the uplink transmission (e.g., transmitting the remaining repetitions) or initiate retransmissions.

The network node may use some information or fields in DCI to indicate to the UE that the current DCI is for HARQ feedback. For example, the information may comprise an uplink shared channel (UL-SCH) indicator and/or a HARQ process ID. To send HARQ feedback for an uplink transmission, the network node may send an uplink DCI (e.g., DCI formats for scheduling a physical uplink shared channel (PUSCH)) to the UE with the HARQ process ID and the UL-SCH indicator. The HARQ process ID may associate with the corresponding uplink data (e.g., the HARQ ID of the uplink transmission the network node wants to ACK/NACK). The UL-SCH indicator may equal to a pre-defined value (e.g., UL-SCH indicator =0). Upon receiving the uplink DCI, the UE may be configured to determine, according to the value of the HARQ-ID and the UL-SCH indicator, that this is an uplink DCI used to indicate HARQ feedback information corresponding to the uplink transmission (e.g., to ACK/NACK the reception of the uplink transmission).

In some implementations, the explicit HARQ feedback may be used for configured grant only. The network node may be configured to send a HARQ feedback (e.g., ACK/NACK) only for an uplink configured-grant transmission. The network node may send an uplink DCI to the UE with the HARQ process ID for the corresponding uplink configured-grant transmission (e.g., the HARQ process ID of the uplink configured-grant transmission the network node wants to ACK/NACK) and the UL-SCH indicator. The UL-SCH indicator may equal to a pre-defined value (e.g., UL-SCH indicator=0). Upon receiving the uplink DCI, the UE may be configured to determine, according to the value of the HARQ process ID and the UL-SCH indicator, that this is an uplink DCI to ACK/NACK reception of the uplink configured-grant transmission.

In some implementations, the DCI type for indicating HARQ feedback information may comprise a UE-specific DCI or a group-common DCI. The network node may use the UE-specific DCI and/or the group-common DCI to indicate the HARQ feedback information. In some implementations, the DCI may comprise a cyclic redundancy check (CRC) scrambled by a configured scheduling-radio network temporary identifier (CS-RNTI). The use of the indicator/field (e.g., UL-SCH indicator) to indicate to the UE that the current DCI is for HARQ feedback may be limited to the case when the DCI comprises the CRC scrambled by the CS-RNTI.

In addition to the HARQ process ID and the UL-SCH indicator, some specific fields or other DCI fields may be set to pre-defined values to indicate to UE that the DCI is for HARQ feedback. For example, these DCI fields may comprise the time-domain resource assignment (RA), or frequency-domain RA, or both time-domain RA and frequency RA fields together. In another example, the modified fields for the time-domain RA and/or frequency-domain RA may be set to all ‘1’s or all ‘0’s to minimize detection errors. Any of the other fields (e.g., besides RA fields) in a DCI scheduling uplink may also be modified in a unique way to indicate to the UE that this is a HARQ feedback. The UE may be configured to determine whether the DCI is used to indicate the HARQ feedback information according to these fields.

In some implementations, the above schemes may be used to indicate ACK only. The DCI for indicating HARQ feedback may be interpreted by the UE as ACK only. In some implementations, the above schemes may be used to indicate either ACK or NACK. A new data indicator (NDI) field in the DCI may be used to indicate whether the HARQ feedback is an ACK or NACK. Alternatively, other DCI field(s) may be used to indicate whether the HARQ feedback is an ACK or NACK.

On the other hand, as monitoring the HARQ-feedback may introduce more complexity to the UE, how to reduce the complexity and the burden of monitoring the HARQ feedback at the UE side should be considered. Specifically, the UE may be configured to perform an uplink transmission. The UE may be configured to determine whether at least one of an uplink transmission type and an uplink transmission parameter corresponding to the uplink transmission meets a condition. The UE may further determine whether to monitor the DCI used to indicate the HARQ feedback information corresponding to the uplink transmission. The UE may determine to monitor the DCI in an event that at least one of the uplink transmission type and the uplink transmission parameter meets the condition.

In some implementations, the uplink transmission type may refer to a grant type of an uplink grant (e.g., a configured grant or a dynamic grant). The condition may comprise that the uplink transmission type comprises a configured-grant uplink transmission. The UE may be configured to determine whether the uplink transmission type is a configured-grant uplink transmission (i.e., whether the condition is met). The UE may be configured to monitor the DCI for HARQ feedback in an event that it transmits the uplink data via the configured grant.

In some implementations, the uplink transmission parameter may refer to a number of uplink transmission repetitions (e.g., K repetitions for PUSCH). The condition may comprise that the number of uplink transmission repetitions is greater than a threshold value. The UE may be configured to determine whether the number of uplink transmission repetitions is greater than a threshold value. The UE may be configured to monitor the DCI for HARQ feedback in an event that the number of the uplink transmission repetitions is larger than threshold value (e.g., K>1). The threshold value may be a pre-defined value or a value configured by the network node.

In some implementations, the UE may be configured to determine whether both of the conditions are met. The UE may be configured to monitor the DCI for HARQ feedback when both of the conditions are met. For example, the UE may be configured to monitor the DCI for HARQ feedback in an event that it transmits the data via the configured grant and the number of the repetitions for the configured grant is larger than a threshold value (e.g., K>1). Other uplink transmission parameters and/or conditions may be used as well for the UE to determine whether to monitor the DCI for HARQ feedback. The UE may be configured by higher-layer signalling (e.g. via radio resource control (RRC) configurations) to indicate the conditions (e.g. uplink transmission type and/or UL transmission parameters) to monitor the DCI for HARQ-feedback. Illustrative Implementations

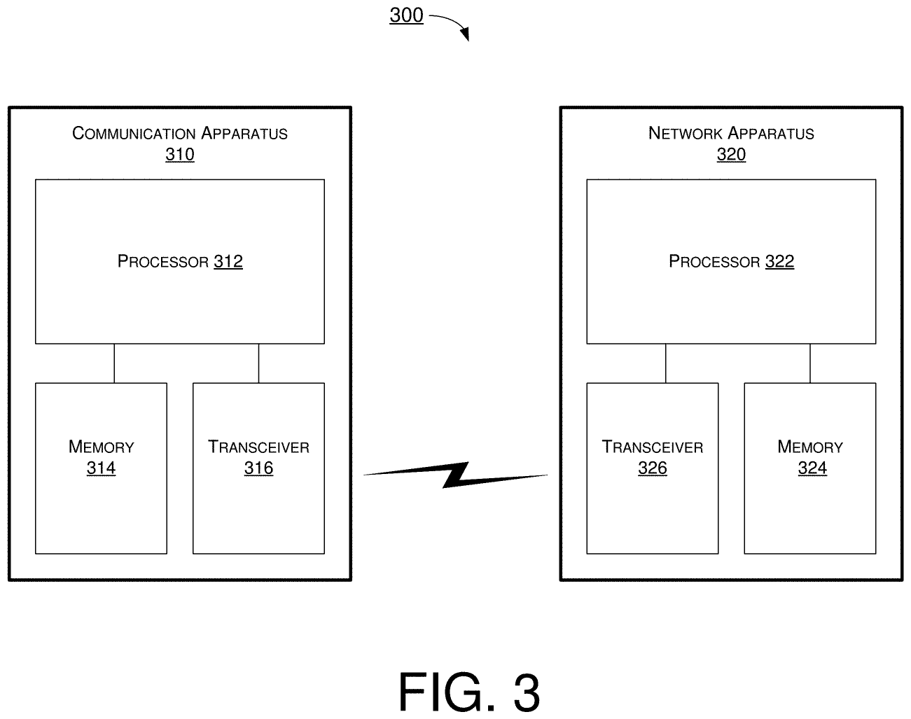

FIG. 3 illustrates an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to HARQ feedback procedures for uplink transmission with respect to user equipment and network apparatus in wireless communications, including scenarios/schemes described above as well as process 500 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT or NB-IoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of an electronic apparatus, which may be a network node such as a base station, a small cell, a router or a gateway. For instance, network apparatus 320 may be implemented in an eNodeB in an LTE, LTE-Advanced or LTE-Advanced Pro network or in a gNB in a 5G, NR, IoT or NB-IoT network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including power consumption reduction in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively. To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE and network apparatus 320 is implemented in or as a network node of a communication network.

In some implementations, processor 312 may be configured to receive, via transceiver 316, a DCI from network apparatus 320. Processor 312 may be configured to determine whether the DCI is used to indicate HARQ feedback information corresponding to an uplink transmission. Processor 312 may be configured to determine the HARQ information according to the DCI in an event that the DCI is used to indicate the HARQ feedback information corresponding to the uplink transmission. Processor 312 may be configured to determine whether to terminate the uplink transmission according to the HARQ information.

In some implementations, in an event that processor 312 determines that the HARQ feedback information is an ACK, processor 312 may terminate the uplink transmission (e.g., the remaining repetitions). In an event that processor 312 determines that the HARQ feedback information is a NACK, processor 312 may continue to perform the uplink transmission (e.g., transmitting the remaining repetitions) or initiate retransmissions.

In some implementations, processor 322 may use some information or fields in DCI to indicate to communication apparatus 310 that the current DCI is for HARQ feedback. For example, processor 322 may use a UL-SCH indicator and/or a HARQ process ID. To send HARQ feedback for an uplink transmission, processor 322 may transmit, via transceiver 326, an uplink DCI (e.g., DCI formats for scheduling a PUSCH) to communication apparatus 310 with the HARQ process ID and the UL-SCH indicator. The HARQ process ID may associate with the corresponding uplink data (e.g., the HARQ ID of the uplink transmission processor 322 wants to ACK/NACK). Processor 322 may configure the UL-SCH indicator as a pre-defined value (e.g., UL-SCH indicator=0).

In some implementations, upon receiving the uplink DCI, processor 312 may be configured to determine, according to the value of the HARQ-ID and the UL-SCH indicator, that this is an uplink DCI used to indicate HARQ feedback information corresponding to the uplink transmission (e.g., to ACK/NACK the reception of the uplink transmission).

In some implementations, processor 322 may use the explicit HARQ feedback for configured grant only. Processor 322 may be configured to transmit, via transceiver 326, a HARQ feedback (e.g., ACK/NACK) only for an uplink configured-grant transmission. Processor 322 may send an uplink DCI to communication apparatus 310 with the HARQ process ID for the corresponding uplink configured-grant transmission (e.g., the HARQ process ID of the uplink configured-grant transmission processor 322 wants to ACK/NACK) and the UL-SCH indicator. Processor 322 may configure the UL-SCH indicator as a pre-defined value (e.g., UL-SCH indicator=0). Upon receiving the uplink DCI, processor 312 may be configured to determine, according to the value of the HARQ process ID and the UL-SCH indicator, that this is an uplink DCI to ACK/NACK reception of the uplink configured-grant transmission.

In some implementations, the DCI type for indicating HARQ feedback information may comprise a UE-specific DCI or a group-common DCI. Processor 322 may use the UE-specific DCI and/or the group-common DCI to indicate the HARQ feedback information.

In some implementations, processor 322 may use the DCI with a CRC scrambled by a CS-RNTI. Processor 322 may be able to use the indicator/field (e.g., UL-SCH indicator) to indicate to communication apparatus 310 that the current DCI is for HARQ feedback when using the DCI with the CRC scrambled by the CS-RNTI.

In some implementations, processor 322 may set some specific fields or other DCI fields to pre-defined values to indicate to communication apparatus 310 that the DCI is for HARQ feedback. For example, processor 322 may use the DCI fields such as the time-domain RA, or frequency-domain RA, or both time-domain RA and frequency RA fields together.

In some implementations, processor 322 may set the modified fields for the time-domain RA and/or frequency-domain RA to all ‘1’s or all ‘0's to minimize detection errors. Processor 322 may also modify any of the other fields (e.g., besides RA fields) in a DCI scheduling uplink in a unique way to indicate to communication apparatus 310 that this is a HARQ feedback. Processor 312 may be configured to determine whether the DCI is used to indicate the HARQ feedback information according to these fields.

In some implementations, processor 322 may indicate ACK only. The DCI for indicating HARQ feedback may be interpreted by processor 312 as ACK only.

In some implementations, processor 322 may indicate either ACK or NACK. Processor 322 may use an NDI field in the DCI to indicate whether the HARQ feedback is an ACK or NACK. Alternatively, processor 322 may use other DCI field(s) to indicate whether the HARQ feedback is an ACK or NACK.

In some implementations, processor 312 may be configured to perform, via transceiver 316, an uplink transmission. Processor 312 may be configured to determine whether at least one of an uplink transmission type and an uplink transmission parameter corresponding to the uplink transmission meets a condition. Processor 312 may further determine whether to monitor the DCI used to indicate the HARQ feedback information corresponding to the uplink transmission. Processor 312 may determine to monitor, via transceiver 316, the DCI in an event that at least one of the uplink transmission type and the uplink transmission parameter meets the condition.

In some implementations, the condition may comprise that the uplink transmission type comprises a configured-grant uplink transmission. Processor 312 may be configured to determine whether the uplink transmission type is a configured-grant uplink transmission (i.e., whether the condition is met). Processor 312 may be configured to monitor the DCI for HARQ feedback in an event that it transmits the uplink data via the configured grant.

In some implementations, the condition may comprise that the number of uplink transmission repetitions is greater than a threshold value. Processor 312 may be configured to determine whether the number of uplink transmission repetitions is greater than a threshold value. Processor 312 may be configured to monitor the DCI for HARQ feedback in an event that the number of the uplink transmission repetitions is larger than threshold value (e.g., K>1).

In some implementations, processor 312 may be configured to determine whether both of the conditions are met. Processor 312 may be configured to monitor the DCI for HARQ feedback when both of the conditions are met. For example, processor 312 may be configured to monitor the DCI for HARQ feedback in an event that it transmits the data via the configured grant and the number of the repetitions for the configured grant is larger than a threshold value (e.g., K>1). Other uplink transmission parameters and/or conditions may be used as well for processor 312 to determine whether to monitor the DCI for HARQ feedback. Processor 312 may be configured by higher-layer signalling (e.g. via RRC configurations) to indicate the conditions (e.g. uplink transmission type and/or UL transmission parameters) to monitor the DCI for HARQ-feedback.

### Illustrative Processes

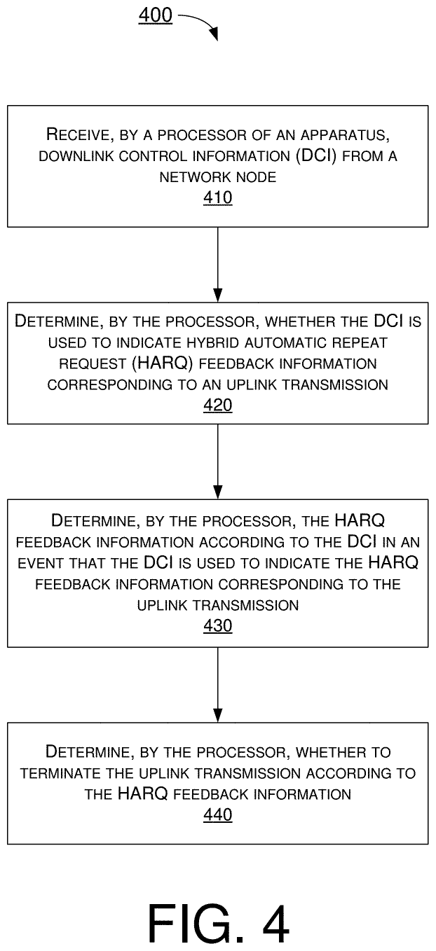

FIG. 4 illustrates an example process 400 in accordance with an implementation of the present disclosure. Process 400 may be an example implementation of above scenarios/schemes, whether partially or completely, with respect to HARQ feedback procedures for uplink transmission with the present disclosure. Process 400 may represent an aspect of implementation of features of communication apparatus 310. Process 400 may include one or more operations, actions, or functions as illustrated by one or more of blocks 410, 420, 430 and 440. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310. Process 400 may begin at block 410.

At 410, process 400 may involve processor 312 of apparatus 310 receiving DCI from a network node. Process 400 may proceed from 410 to 420.

At 420, process 400 may involve processor 312 determining whether the DCI is used to indicate HARQ feedback information corresponding to an uplink transmission. Process 400 may proceed from 420 to 430.

At 430, process 400 may involve processor 312 determining the HARQ feedback information according to the DCI in an event that the DCI is used to indicate the HARQ feedback information corresponding to the uplink transmission. Process 400 may proceed from 430 to 440.

At 440, process 400 may involve processor 312 determining whether to terminate the uplink transmission according to the HARQ feedback information.

In some implementations, the DCI may comprise a UE-specific DCI or a group-common DCI.

In some implementations, the DCI may comprise a CRC scrambled by a CS-RNTI.

In some implementations, the DCI may comprise at least one of a HARQ process ID corresponding to the uplink transmission, a UL-SCH indicator, and a specific DCI field.

In some implementations, process 400 may involve processor 312 determining whether the DCI is used to indicate the HARQ feedback information according to at least one of the HARQ process ID corresponding to the uplink transmission, the UL-SCH indicator, and the specific DCI field.

In some implementations, the uplink transmission may comprise a configured-grant uplink transmission.

In some implementations, process 400 may involve processor 312 terminating the uplink transmission in an event that the HARQ feedback information is determined as an ACK.

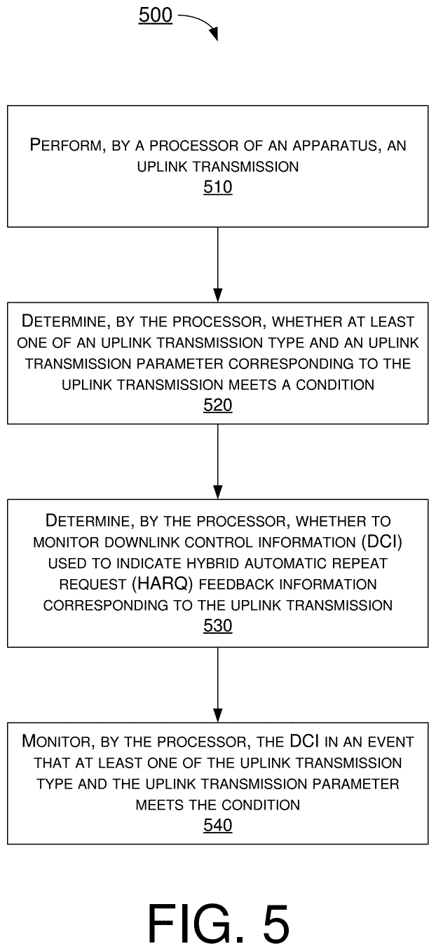

FIG. 5 illustrates an example process 500 in accordance with an implementation of the present disclosure. Process 500 may be an example implementation of above scenarios/schemes, whether partially or completely, with respect to HARQ feedback procedures for uplink transmission with the present disclosure. Process 500 may represent an aspect of implementation of features of communication apparatus 310. Process 500 may include one or more operations, actions, or functions as illustrated by one or more of blocks 510, 520, 530 and 540. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Process 500 may be implemented by communication apparatus 310 or any suitable UE or machine type devices. Solely for illustrative purposes and without limitation, process 500 is described below in the context of communication apparatus 310. Process 500 may begin at block 510.

At 510, process 500 may involve processor 312 of apparatus 310 performing an uplink transmission. Process 500 may proceed from 510 to 520.

At 520, process 500 may involve processor 312 determining whether at least one of an uplink transmission type and an uplink transmission parameter corresponding to the uplink transmission meets a condition. Process 500 may proceed from 520 to 530.

At 530, process 500 may involve processor 312 determining whether to monitor DCI used to indicate HARQ feedback information corresponding to the uplink transmission. Process 500 may proceed from 530 to 540.

At 540, process 500 may involve processor 312 monitoring the DCI in an event that at least one of the uplink transmission type and the uplink transmission parameter meets the condition.

In some implementations, the condition may comprise that the uplink transmission type comprises a configured-grant uplink transmission.

In some implementations, the uplink transmission parameter may comprise a number of uplink transmission repetitions. The condition may comprise that the number of uplink transmission repetitions is greater than a threshold value.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, downlink control information (DCI) from a network node;
determining, by the processor, whether the DCI is used to indicate hybrid automatic repeat request (HARQ) feedback information corresponding to an uplink transmission;
determining, by the processor, the HARQ feedback information according to the DCI in an event that the DCI is used to indicate the HARQ feedback information corresponding to the uplink transmission; and
determining, by the processor, whether to terminate the uplink transmission according to the HARQ feedback information.

2. The method of claim 1, wherein the DCI comprises a user equipment (UE)-specific DCI or a group-common DCI.

3. The method of claim 1, wherein the DCI comprises a cyclic redundancy check (CRC) scrambled by a configured scheduling-radio network temporary identifier (CS-RNTI).

4. The method of claim 1, wherein the DCI comprises at least one of a HARQ process identifier (ID) corresponding to the uplink transmission, an uplink shared channel (UL-SCH) indicator, and a specific DCI field.

5. The method of claim 4, wherein the determining comprises determining whether the DCI is used to indicate the HARQ feedback information according to at least one of the HARQ process ID corresponding to the uplink transmission, the UL-SCH indicator, and the specific DCI field.

6. The method of claim 1, wherein the uplink transmission comprises a configured-grant uplink transmission.

7. The method of claim 1, further comprising:
terminating, by the processor, the uplink transmission in an event that the HARQ feedback information is determined as an acknowledgement (ACK).

8. A method, comprising:
performing, by a processor of an apparatus, an uplink transmission;
determining, by the processor, whether at least one of an uplink transmission type and an uplink transmission parameter corresponding to the uplink transmission meets a condition;
determining, by the processor, whether to monitor downlink control information (DCI) used to indicate hybrid automatic repeat request (HARQ) feedback information corresponding to the uplink transmission; and
monitoring, by the processor, the DCI in an event that at least one of the uplink transmission type and the uplink transmission parameter meets the condition.

9. The method of claim 8, wherein the condition comprises that the uplink transmission type comprises a configured-grant uplink transmission.

10. The method of claim 8, wherein the uplink transmission parameter comprises a number of uplink transmission repetitions, and wherein the condition comprises that the number of uplink transmission repetitions is greater than a threshold value.

11. An apparatus, comprising:
a transceiver which, during operation, wirelessly communicates with a network node of a wireless network; and
a processor communicatively coupled to the transceiver such that, during operation, the processor performs operations comprising:
receiving, via the transceiver, downlink control information (DCI) from the network node;
determining whether the DCI is used to indicate hybrid automatic repeat request (HARQ) feedback information corresponding to an uplink transmission;
determining the HARQ feedback information according to the DCI in an event that the DCI is used to indicate the HARQ feedback information corresponding to the uplink transmission; and
determining whether to terminate the uplink transmission according to the HARQ feedback information.

12. The apparatus of claim 11, wherein the DCI comprises a user equipment (UE)-specific DCI or a group-common DCI.

13. The apparatus of claim 11, wherein the DCI comprises cyclic redundancy check (CRC) scrambled by configured scheduling-radio network temporary identifier (CS-RNTI).

14. The apparatus of claim 11, wherein the DCI comprises at least one of a HARQ process identifier (ID) corresponding to the uplink transmission, an uplink shared channel (UL-SCH) indicator, and a specific DCI field.

15. The apparatus of claim 14, wherein, in determining whether the DCI is used to indicate the HARQ feedback information, the processor determines whether the DCI is used to indicate the HARQ feedback information according to at least one of the HARQ process ID corresponding to the uplink transmission, the UL-SCH indicator, and the specific DCI field.

16. The apparatus of claim 11, wherein the uplink transmission comprises a configured-grant uplink transmission.

17. The apparatus of claim 11, wherein, during operation, the processor further performs operations comprising:
terminating the uplink transmission in an event that the HARQ feedback information is determined as an acknowledgement (ACK).

18. An apparatus, comprising:
a transceiver which, during operation, wirelessly communicates with a network node of a wireless network; and
a processor communicatively coupled to the transceiver such that, during operation, the processor performs operations comprising:
performing, via the transceiver, an uplink transmission;
determining whether at least one of an uplink transmission type and an uplink transmission parameter corresponding to the uplink transmission meets a condition;
determining whether to monitor downlink control information (DCI) used to indicate hybrid automatic repeat request (HARQ) feedback information corresponding to the uplink transmission; and
monitoring, via the transceiver, the DCI in an event that at least one of the uplink transmission type and the uplink transmission parameter meets the condition.

19. The apparatus of claim 18, wherein the condition comprises that the uplink transmission type comprises a configured-grant uplink transmission.

20. The apparatus of claim 18, wherein the uplink transmission parameter comprises a number of uplink transmission repetitions, and wherein the condition comprises that the number of uplink transmission repetitions is greater than a threshold value.
